(19) United States
(12) Patent Application Publication
(10) Pub. No.: US 2017/0075242 A1
(43) Pub. Date: Mar. 16, 2017

(54) ELECTROSTATIC CHARGE IMAGE DEVELOPING TONER, ELECTROSTATIC CHARGE IMAGE DEVELOPER, AND TONER CARTRIDGE

(71) Applicant: FUJI XEROX CO., LTD., Tokyo (JP)

(72) Inventors: Motoko SAKAI, Kanagawa (JP); Shuji SATO, Kanagawa (JP); Masaaki USAMI, Kanagawa (JP); Takuro WATANABE, Kanagawa (JP)

(73) Assignee: FUJI XEROX CO., LTD., Tokyo (JP)

(21) Appl. No.: 15/008,798

(22) Filed: Jan. 28, 2016

(30) Foreign Application Priority Data
Sep. 15, 2015 (JP) 2015-182039

(51) Int. Cl. G03G 9/08; G03G 9/09; G03G 9/087; G03G 15/08

(52) U.S. Cl. CPC G03G 9/0819; G03G 15/0865; G03G 9/0902; G03G 9/08755

(57) ABSTRACT

An electrostatic charge image developing toner includes toner particles including a binder resin and a metallic pigment and silica particles having an equivalent circle diameter E of greater than 0.10 μm, wherein a relationship between a number-average maximum thickness C and a number-average equivalent circle diameter D of the toner particles satisfies 0.700<C/D<1.220, a number-average equivalent circle diameter d of the silica particles satisfies 0.10 μm<d<0.30 μm, and the content of silica particles, having a ratio F/G of a circumferential length F to a circumference G calculated from the equivalent circle diameter E of 1.10 to 3.00, with respect to the total number of silica particles is 30% by number to 100% by number.

### CROSS-REFERENCE TO RELATED APPLICATIONS

This application is based on and claims priority under 35 USC 119 from Japanese Patent Application No. 2015-182039 filed Sep. 15, 2015.

### BACKGROUND

1. Technical Field

The present invention relates to an electrostatic charge image developing toner, an electrostatic charge image developer, and a toner cartridge.

2. Related Art

A method of visualizing image information through an electrostatic charge image, such as electrophotography, has been currently used in various fields.

In the electrophotography in the related art, a method of visualizing image information through plural steps of forming an electrostatic latent image on a photoreceptor or an electrostatic recording member using various units, developing the electrostatic latent image (toner image) by making voltage detecting particles called toner to adhere to the electrostatic latent image, transferring the image to a surface of a transfer medium, and fixing the image to the transfer medium by heating or the like, has been generally used.

Among toners, for the purpose of forming an image having brilliance similar to metallic luster, a brilliant toner has been used.

### SUMMARY

According to an aspect of the invention, there is provided an electrostatic charge image developing toner including:

toner particles including a binder resin and a metallic pigment; and

silica particles having an equivalent circle diameter E of greater than 0.10 μm,

wherein a relationship between a number-average maximum thickness C and a number-average equivalent circle diameter D of the toner particles satisfies 0.700<C/D<1.220,

a number-average equivalent circle diameter d of the silica particles satisfies 0.10 μm<d<0.30 μm, and

the content of silica particles having a ratio F/G of a circumferential length F to a circumference G calculated from the equivalent circle diameter E of 1.10 to 3.00 is 30% by number to 100% by number with respect to the total number of silica particles.

### BRIEF DESCRIPTION OF THE DRAWINGS

Exemplary embodiments of the present invention will be described in detail based on the following figures, wherein:

FIG. 1 is a plan diagram schematically showing an example of an electrostatic charge image developing toner according to an exemplary embodiment;

FIG. 2 is a plan diagram schematically showing an example of specific silica particles according to an exemplary embodiment;

FIG. 3 is a schematic configuration diagram showing an example of an image forming apparatus according to an exemplary embodiment including a developing device to which an electrostatic charge image developer according to an exemplary embodiment is applied; and

FIG. 4 is a schematic configuration diagram showing an example of a process cartridge suitably used as an exemplary embodiment.

### DETAILED DESCRIPTION

Hereinafter, exemplary embodiments will be described.

In the exemplary embodiments, the expression “A to B” includes not only a range between A to B but also a range including A and B, which are both ends thereof. For example, when “A to B” is a numerical range, the “A to B” represents “from A to B” or “from B to A”.

Further, in the following description, a combination of preferable embodiments is a more preferable embodiment.

Electrostatic Charge Image Developing Toner

An electrostatic charge image developing toner according to the exemplary embodiment (hereinafter, also simply referred to as “toner” or “brilliant toner”) contains toner particles including a binder resin and a metallic pigment, and silica particles whose equivalent circle diameter E is greater than 0.10 μm (hereinafter, also referred to as “specific silica particles”), and a relationship between a number-average maximum thickness C and a number-average equivalent circle diameter D of the toner particles satisfies 0.700<C/D<1.220, a number-average equivalent circle diameter d of the silica particles satisfies 0.10 μm<d<0.30 μm, and the content of silica particles, having a ratio F/G of a circumferential length F to a circumference G calculated from the equivalent circle diameter E of 1.10 to 3.00, with respect to the total number of the silica particles is 30% by number to 100% by number.

In the toner including a metallic pigment as a coloring agent, in order to obtain an image exhibiting sufficient brilliance, it is preferable that the particle diameter of the metallic pigment is large.

The inventors have found that when a toner including such a pigment having large particles is prepared by a dry method, cracks are easily formed around the metallic pigment by the impact of pulverization, and a toner structure in which a metallic pigment is present on the surface or near the surface of the toner is easily formed. In addition, when the toner is prepared by a wet method, particularly, a melt and suspension method is adopted, a metallic pigment insoluble in an organic solvent or a resin hardly soluble in an organic solvent functions as a nucleus and granulation proceeds. However, it has been found that since there is a case in which the particle size of a metallic pigment is almost as large as the particle size of a toner, or a case in which there is a difference in affinity between a metallic pigment and a resin, a toner structure in which a metallic pigment is present on the surface or near the surface of the toner is easily formed.

In addition, the inventors have found that the aggregation between toner particles occurs due to a difference in the rising charge degree in a portion in which a metallic pigment is present on the surface or near the surface and a portion in which a metallic pigment is not present on the surface or near the surface and the above-described phenomenon remarkably occurs particularly in continuous printing in a low temperature and low humidity environment. It has been found that when the aggregated toner particles are included in a toner layer on a fixed member, there arise problems that the metallic pigment is not uniformly arranged on the toner layer of the fixed member and the brilliance of an image to be obtained is not sufficient.

As a result of detailed investigations, the inventors have found that the electrostatic charge image developing toner according to the exemplary embodiment has excellent brilliance in an image to be obtained even in continuous printing in a low temperature and low humidity environment.

Although a detailed mechanism by which the effect may be obtained is not clear, it is presumed that the portion in which the metallic pigment is present on the surface or near the surface of the toner in the exemplary embodiment easily becomes a toner projection portion but since the specific silica particles in the exemplary embodiment have a specific particle diameter and the shape thereof is distorted, the particles do not easily roll on the surface of the toner and are fixed to any of the projection portions of the surface of the toner and portions other than the projection portions. Therefore, it is presumed that the surface charge of the toner may be made uniform, aggregated toner particles are easily released by fixing stress in a fixing step, an image in which the metallic pigment is uniformly arranged is easily formed, and the brilliance of an image to be obtained is excellent. In addition, it is presumed that the effect by the mechanism may be easily obtained particularly in a toner prepared by a dry method.

Hereinafter, each component constituting the toner and physical properties thereof will be described in detail.

The “brilliance” in the exemplary embodiment indicates that an image has brilliance similar to metallic luster when the image formed by the toner is visually checked. In the quantitative description of the “metallic luster”, it is preferable that a ratio (A/B) between a reflectance A at a light receiving angle of +30° measured in the case of forming a solid image which is irradiated with incident light at an incident angle of −45° by a goniophotometer and a reflectance B at a light receiving angle of −30° is from 2 to 100. It is more preferable that the ratio (A/B) is from 4 to 100. When the ratio is within the above range, metallic luster may be observed at a wide viewing angle and a color image may be prevented from exhibiting a dull color. The measurement of the ratio (A/B) is performed on a solid image in which an amount of toner applied is 4.5 g/m² using a goniophotometer. The “solid image” refers to an image with a coverage rate of 100%.

Measurement of Ratio (A/B)

First, an incident angle and a light receiving angle will be described. In the exemplary embodiment, when the measurement is performed using a goniophotometer, the incident angle is set to −45°. This is because the sensitivity of the measurement is high with respect to images of a wide range of brilliance.

In addition, the reason why the light receiving angle is set to −30° and +30° is that the sensitivity of the measurement is the highest for evaluating images having and not having the impression of brilliance.

Next, the method of measuring the ratio (A/B) will be described.

In the exemplary embodiment, when the ratio (A/B) is measured, first, a “solid image” is formed in the following manner. A developer as a sample is filled in a developing unit of a DocuCentre-III C7600 manufactured by Fuji Xerox Co., Ltd., and a solid image in which an amount of toner applied is 4.5 g/m² is formed on a sheet of recording paper (OK Topcoat+Paper manufactured by Oji Paper Co., Ltd.) at a fixing temperature of 190° C. and at a fixing pressure of 4.0 kg/cm².

By using a goniospectrocolorimeter GC5000L manufactured by NIPPON DENSHOKU INDUSTRIES CO., LTD. as a goniophotometer, incident light that enters the solid image at an incident angle of −45° enters the image portion of the formed solid image, and the reflectance A at a light receiving angle of +30° and the reflectance B at a light receiving angle of −30° are measured. The reflectances A and B are measured with respect to light having a wavelength ranging from 400 nm to 700 nm at an interval of 20 nm, and the average value of the reflectance at each wavelength is calculated. The ratio (A/B) is calculated from the measurement results.

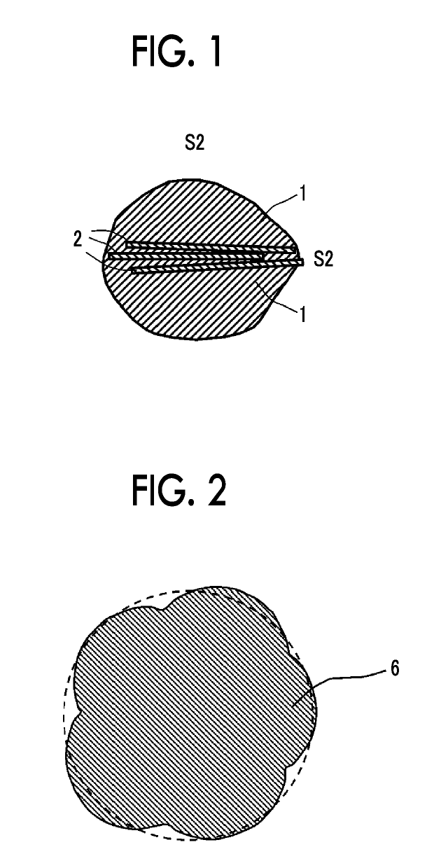

Referring to FIG. 1, the toner according to the exemplary embodiment will be schematically described. FIG. 1 is a schematic diagram showing an example of toner particles included in the toner of the exemplary embodiment. The toner particle contains a binder resin 1 and a metallic pigment 2. The entire shape of the brilliant toner particle is close to a spherical shape and the particle section parallel to the thickness of the toner particles includes a flaky section of the metallic pigment 2.

The vicinity of S1 in FIG. 1 is a portion in which the metallic pigment is present on the surface or near the surface, which easily becomes a toner projection portion. In addition, the vicinity of S2 in FIG. 1 is a portion in which the metallic pigment is not present on the surface or near the surface.

Toner Particles

The toner particles in the electrostatic charge image developing toner of the exemplary embodiment include a binder resin and a metallic pigment, and a relationship between the number-average maximum thickness C and the number-average equivalent circle diameter D satisfies 0.700<C/D<1.220.

Number-Average Maximum Thickness C and Number-Average Equivalent Circle Diameter D of Toner Particles

As described above, the shape of the toner particles is not a flake shape. That is, the relationship between the number-average maximum thickness C and the number-average equivalent circle diameter D satisfies 0.700<C/D<1.220.

In addition, the value of a ratio (C/D) in the toner particles is preferably 0.750<C/D<0.850.

The number-average maximum thickness C and the number-average equivalent circle diameter D are measured by the following manner.

Toner particles are placed on a smooth surface and uniformly dispersed by applying vibrations. 100 toner particles are observed with a color laser microscope “VK-9700” (manufactured by Keyence Corporation) at a magnification of 1,000 times to measure the maximum thickness C and the equivalent circle diameter D calculated from the projection area of a surface viewed from the top, and the arithmetic averages thereof are calculated to determine the number-average maximum thickness C and the average equivalent circle diameter D.

Metallic Pigment

The toner particles in the exemplary embodiment contain a metallic pigment.

Examples of the metallic pigment used in the toner particles in the exemplary embodiment include powders of metals suchas aluminum, brass, bronze, nickel, stainless steel, zinc, copper, silver, gold, and platinum, metal-deposited flaky glass powder. Among these metallic pigments, particularly, from the viewpoint of ease of availability, aluminum is most preferable. The surface of the metallic pigment may be coated with silica particles, an acrylic resin, a polyester resin and the like. The metallic pigment preferably has a flake-shape. In addition, in the metallic pigment, the number-average equivalent circle diameter of the metallic pigment is preferably longer than the number-average maximum thickness of the metallic pigment.

The metallic pigments may be used alone or in combination with two or more kinds thereof.

The content of the metallic pigment used in the toner of the exemplary embodiment is preferably from 1 part by weight to 70 parts by weight and more preferably from 5 parts by weight to 50 parts by weight with respect to 100 parts by weight of the toner.

Binder Resin

The toner particles of the exemplary embodiment contain a binder resin.

Examples of the binder resin include a homopolymer formed from monomers such as styrenes (for example, styrene, p-chlorostyrene, α-methyl styrene, or the like), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, or the like), ethylenic unsaturated nitriles (for example, acrylonitrile, methacrylonitrile, or the like), vinyl ethers (for example, vinyl methyl ether, vinyl isobutyl ether, or the like), vinyl ketones (for example, vinyl methyl ketone, vinyl ethyl ketone, vinyl isopropenyl ketone, or the like), olefins (for example, ethylene, propylene, butadiene, or the like), or a vinyl resin formed of a copolymer obtained by combining two or more kinds of these monomers.

Examples of the binder resin include a non-vinyl resin such as an epoxy resin, a polyester resin, a polyurethane resin, a polyamide resin, a cellulose resin, a polyether resin, and a modified rosin, a mixture of these and a vinyl resin, or a graft polymer obtained by polymerizing a vinyl monomer in the presence thereof.

These binder resins may be used alone or in combination with two or more kinds thereof.

As the binder resin, a polyester resin is preferable.

As the polyester resin, a well-known polyester resin is used, for example.

Examples of the polyester resin include polycondensates of polyvalent carboxylic acids and polyols. A commercially available product or a synthesized product may be used as the polyester resin.

Examples of the polyvalent carboxylic acid include aliphatic dicarboxylic acids (e.g., oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination together with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adduct of bisphenol A and propylene oxide adduct of bisphenol A). Among these, for example, aromatic diols and alicyclic diols are preferably used, and aromatic diols are more preferably used as the polyol.

As the polyol, a tri- or higher-valent polyol employing a crosslinked structure or a branched structure may be used in combination together with a diol. Examples of the tri- or higher-valent polyol include glycerin, trimethylolpropane, and pentaerythritol.

The polyols may be used alone or in combination of two or more kinds thereof.

The glass transition temperature (Tg) of the polyester resin is preferably from 50° C. to 80° C., and more preferably from 50° C. to 65° C.

The glass transition temperature is determined by a DSC curve obtained by differential scanning calorimetry (DSC), and more specifically, is determined by “Extrapolated Starting Temperature of Glass Transition” disclosed in a method of determining a glass transition temperature of JIS K7121-1987 “Testing Methods for Transition Temperature of Plastics”.

The weight-average molecular weight (Mw) of the polyester resin is preferably from 5, 000 to 1,000,000, and more preferably from 7,000 to 500,000.

The number-average molecular weight (Mn) of the polyester resin is preferably from 2,000 to 100,000.

The molecular weight distribution Mw/Mn of the polyester resin is preferably from 1.5 to 100, and more preferably from 2 to 60.

The weight-average molecular weight and the number-average molecular weight are measured by gel permeation chromatography (GPC). The molecular weight measurement by GPC is performed with a THF solvent using GPC•HLC-8120 GPC manufactured by Tosoh Corporation as a measurement device by using a column TSKgel Super HM-M (15 cm) manufactured by Tosoh Corporation. The weight-average molecular weight and the number-average molecular weight are calculated using a calibration curve of molecular weight created with a monodisperse polystyrene standard sample from results of this measurement.

A known preparing method is applied to prepare the polyester resin. Specific examples thereof include a method of conducting a reaction at a polymerization temperature set to 180° C. to 230° C., if necessary, under reduced pressure in the reaction system, while removing water or an alcohol generated during condensation.

When monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. When a monomer having poor compatibility is present in a copolymerization reaction, the monomer having poor compatibility and an acid or an alcohol to be polycondensed with the monomer may be previously condensed and then polycondensed with the major component.

The total content of the binder resin is, for example, preferably from 40% by weight to 95% by weight, more preferably from 50% by weight to 90% by weight, and even more preferably from 60% by weight to 85% by weight with respect to the entirety of the toner particles.

Release Agent

The toner particles of the toner of the exemplary embodiment preferably contain a release agent.

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited thereto.

Specific examples of the release agent are ester wax, polyethylene, polypropylene, or polyethylene-polypropylene copolymers, but include unsaturated fatty acids such as polyglycerin wax, microcrystalline wax, paraffin wax, carnauba wax, sasol wax, montanic acid ester wax, deoxidized carnauba wax, palmitic acid, stearic acid, montanic acid, brassidic acid, eleostearic acid, and parinaric acid; saturated alcohols such as stearyl alcohol, aralkyl alcohol, behenyl alcohol, carnaubyl alcohol, ceryl alcohol, melissyl alcohol, and long-chain alkyl alcohols having longer-chain alkyl groups; polyols such as sorbitol; fatty acid amides such as linoleic acid amide, oleic acid amide, and lauric acid amide; saturated fatty acid bis-amides such as methylene-bis-stearic acid amide, ethylene-bis-capric acid amide, ethylene-bis-lauric acid amide, and hexamethylene-bis-stearic acid amide; unsaturated fatty acid amides such as ethylene-bis-oleic acid amide, hexamethylene-bis-oleic acid amide, N,N′-dioleyladipic acid amide, and N,N′-dioleylsebacic acid amide; aromatic bis-amides such as m-xylene-bis-stearic acid amide and N,N′-distearylisophthalic acid amide; fatty acid metal salts (generally called metallic soap) such as calcium stearate, calcium laurate, zinc stearate, and magnesium stearate; grafted waxes obtained by grafting aliphatic hydrocarbon waxes with vinyl monomers such as styrene and acrylic acid; partially esterified compounds between a fatty acid and a polyol such as behenic acid monoglyceride; and methyl ester compounds having a hydroxyl group and obtained by hydrogenating vegetable fat and oil.

The release agents may be used alone or in combination of two or more kinds thereof.

The content of the release agent is preferably in a range of 1% by weight to 20% by weight and more preferably in a range of 3% by weight to 15% by weight with respect to 100 parts by weight of the binder resin. When the content of the release agent is in the above range, satisfactory fixing and image properties may be attained.

Other Coloring Agents

The toner particles in the exemplary embodiment may contain coloring agents other than the metallic pigment if necessary.

As other coloring agents, known coloring agents may be used. From the viewpoint of hue angle, chroma, luminosity, weather resistance, OHP transparency, and dispersiveness in the toner, the coloring agent may be selected.

Specific examples thereof include various pigments such as watch young red, permanent red, brilliant carmin 3B, brilliant carmin 6B, Du Pont oil red, pyrazolone red, lithol red, Rhodamine B Lake, Lake Red C, and rose bengal, and various coloring agents such as acridine coloring agents, xanthene coloring agents, azo coloring agents, benzoquinone coloring agents, azine coloring agents, anthraquinone coloring agents, thioindigo coloring agents, dioxadine coloring agents, thiazine coloring agents, azomethine coloring agents, indigo coloring agents, phthalocyanine coloring agents, aniline black coloring agents, polymethine coloring agents, triphenylmethane coloring agents, diphenylmethane coloring agents, and thiazole coloring agents.

As specific examples of other coloring agents, carbon black, nigrosine dye (C.I. No. 50415B), aniline blue (C.I. No. 50405), calco oil blue (C.I. No. azoic Blue 3), chromium yellow (C.I. No. 14090), ultramarine blue (C.I. No. 77103), Du Pont oil red (C.I. No. 26105), quinoline yellow (C.I. No. 47005), methyl blue chloride (0.1. No. 52015), phthalocyanine blue (C.I. No. 74160), malachite green oxalate (C.I. No. 42000), lamp black (C.I. No. 77266), Rose Bengal (C.I. No. 45435), and mixtures thereof are preferably used.

The amount of other coloring agents used is preferably 0.1 parts by weight to 20 parts by weight and more preferably 0.5 parts by weight to 10 parts by weight with respect to 100 parts by weight of the toner particles. In addition, as the coloring agent, these pigments and dyes may be used alone or in combination of two or more kinds thereof.

As a method of dispersing other coloring agents, an arbitrary method, for example, a common dispersing method using, for example, a rotary shearing-type homogenizer, or a ball mill, a sand mill, or a Dyno mill having media may be used and there is no limitation thereto. In addition, the coloring gent particles of these agents may be added to a mixed solvent with other particle components at one time or in parts at multiple stages.

Other Components

Further, if necessary, various components such as an internal additive, a charge-controlling agent, an inorganic powder (inorganic particles), and organic particles, other than the above-described components, may be added to the toner of the exemplary embodiment.

Examples of the internal additive include magnetic substances of metals and alloys, such as ferrite, magnetite, reduced iron, cobalt, nickel, and manganese, and compounds including these metals. When the toner is used as a magnetic toner by incorporating the magnetic substances, the average particle diameter of the ferromagnetic material thereof is preferably 2 μm or less and more preferably approximately from 0.1 μm to 0.5 μm. The amount of the magnetic substance contained in the toner is preferably from 20 parts by weight to 200 parts by weight with respect to 100 parts by weight of the resin component and is particularly preferably from 40 parts by weight to 150 parts by weight with respect to 100 parts by weight of the resin component. In addition, it is preferable that as magnetic properties under application of 10K oersteds, a coercive force (Hc) is from 20 oersteds to 300 oersteds, a saturation magnetization (σs) is from 50 emu/g to 200 emu/g, and a residual magnetization (σr) is from 2 emu/g to 20 emu/g.

Examples of the charge-controlling agent include fluorine surfactants, metal containing dyes, such as salicylic acid metal complexes and azo metal compounds, polymeric acids, such as copolymers containing a maleic acid as the monomer unit, quaternary ammonium salts, and azine dyes, such as nigrosine.

The toner particles may include an inorganic powder for the purpose of adjusting a viscoelasticity. Examples of the inorganic powder include all of inorganic particles, such as silica, alumina, titania, calcium carbonate, magnesium carbonate, calcium phosphate, and cerium oxide, which are typically used as external additives on the toner surface, as described in detail below.

Physical Properties of Toner Particles

The volume average particle diameter of the toner particles according to the exemplary embodiment is preferably from 1 μm to 30 μm, and more preferably from 10 μm to 20 μm. The value of the volume average particle diameter means the average with respect to a sphere equivalent diameter.

The volume average particle diameter D₅₀ᵥ is determined as follows. A cumulative volume distribution curve and a cumulative number distribution curve are drawn from the smaller particle diameter end, respectively, for each particle diameter range (channel) divided on the basis of a particle diameter distribution measured with a measuring instrument such as a Coulter Multisizer II (manufactured by Beckman Coulter Inc.). The particle diameter providing 16% accumulation is defined as that corresponding to volume D₁₆ᵥ and number D₁₆ₚ, the particle diameter providing 50% accumulation is defined as that corresponding to volume D₅₀ᵥ and number D₅₀ₚ, and the particle diameter providing 84% accumulation is defined as that corresponding to volume D₈₄ᵥ and number D₈₄ₚ. The volume average particle diameter distribution index (GSDv) is calculated as (D₈₄ᵥ/D₁₆ᵥ)^{1/2} using these values.

The shape factor SF1 of the toner particles is preferably from 110 to 150, and more preferably from 120 to 140.

The average particle diameter of particles such as toner particles is measured using as a Coulter Multisizer II (manufactured by Beckman Coulter Inc.). In this case, the measurement may be performed using the optimum aperture according to the particle size level of the particles. The measured particle diameters of the particles are expressed as a volume average particle size.

When the particle diameter of the particles is about 5 μm or less, the particle diameter may be measured by using a laser diffraction-type particle diameter distribution measuring device (for example, LA-700, manufactured by Horiba, Ltd.).

Further, when the particle diameter has nanometer-order, the particle diameter is measured by a BET specific surface area measuring device (Flow SorbI12300, manufactured by Shimadzu Corporation).

External Additives

Specific Silica Particles

The toner of the exemplary embodiment contains specific silica particles as an external additive. In the specific silica particles, the content of silica particles, in which the equivalent circle diameter E is greater than 0.10 μm, the number-average equivalent circle diameter d satisfies 0.10 μm<d<0.30 μm, a ratio F/G of the circumferential length F to the circumference G calculated from the equivalent circle diameter E is 1.10 to 3.00, is 30% by number to 100% by number with respect to the total number of the specific silica particles.

The ratio F/G of the circumferential length F to the circumference G calculated from the equivalent circle diameter E is referred to as surface unevenness. As the surface unevenness increases, the degree of unevenness on the particle surface is large.

Equivalent Circle Diameter E, Number-average Equivalent Circle Diameter d, Circumferential Length F, Circumference G, and Surface Unevenness

After the external additive is added to the toner particles, the primary particles of the external additive are observed with a scanning electron microscope at a at a magnification of 40,000 times, and the equivalent circle diameter E is obtained from the image analysis of the primary particles obtained by using image analysis software WinRoof (manufactured by Mitani Corporation). As the number-average value of particles having an equivalent circle diameter E>0.10 μm, the number-average equivalent circle diameter d is obtained.

Further, with respect to silica particles having an equivalent circle diameter E greater than 0.10 μm, a ratio F/G of the circumferential length F to the circumference G calculated from the equivalent circle diameter E is calculated and the content (% by number) of silica particles, having a ratio F/G of the circumferential length F to the circumference G calculated from the equivalent circle diameter E of 1.10 to 3.00, with respect to the total number of the specific silica particles, is calculated by Equation A below.

Circumference G=2π×(equivalent circle diameter E)/2

(number of silica particles having an F/G of 1.50 to 3.50 among silica particles having an equivalent circle diameter E of greater than 0.10 μm)/(number of silica particles having an equivalent circle diameter E of greater than 0.10 μm) (A)

The number-average equivalent circle diameter d of the specific silica particles in the exemplary embodiment satisfies 0.10μm<d<0.30 μm and is preferably 0.15 μm to 0.25 μm.

The content of silica particles, having the ratio of the circumferential length F to the circumference G calculated from the equivalent circle diameter E of 1.10 to 3.00, with respect to the total number of the specific silica particles is 30% by number to 100% by number, preferably 50% by number to 100% by number, and more preferably 60% by number to 100% by number. When the content is within the above range, an electrostatic charge image developing toner having excellent brilliance in an image to be formed is obtained.

The content of the specific silica particles is preferably from 0.1 part by weight to 10 parts by weight, more preferably from 0.2 parts by weight to 5 parts by weight, and still more preferably from 0.3 parts by weight to 3 parts by weight with respect to 100 parts by weight of the toner particles.

Referring to FIG. 2, the specific silica particles in the exemplary embodiment will be schematically described. FIG. 2 is a schematic diagram showing an example of specific silica particles included in the toner of the exemplary embodiment. FIG. 2 shows a projection of a specific silica particle 6, and the circle indicated by a broken line represents the equivalent circle diameter of the silica particle.

Method of Preparing Specific Silica Particles

The method of preparing the specific silica particles in the exemplary embodiment is not particularly limited and a known method may be used. For example, the silica particles are prepared by a gas phase method or a sol-gel method, and from the viewpoint of surface unevenness of the specific silica particles or shape control, such as an equivalent circle diameter, being possible, and a reduction in electric resistance, are preferably prepared by a sol-gel method. Hereinafter, a sol-gel method will be briefly described.

Sol-Gel Method

In the method of preparating the specific silica particles by a sol-gel method, the particle diameter and the shape may be freely controlled by hydrolysis, the weight ratio of alkoxysilane, ammonia, alcohol and water in the polycondensation step, reaction temperature, stirring velocity and supplying velocity.

That is, tetramethoxysilane is added dropwise in the presence of water and an alcohol using an ammonia aqueous solution as a catalyst while a temperature is applied, and the mixture is stirred. Then, a solvent is removed from a silica sol suspension liquid obtained by the reaction and the gel is dried to obtain target silica particles.

Then, the obtained silica particles are treated with a hydrophobizing agent if necessary.

While the specific silica particles are prepared by the sol-gel method, the surfaces of the silica particles may be treated with a hydrophobizing agent.

In this case, as described above, the silica sol suspension liquid obtained by the reaction is separated into a wet silica gel, alcohol, and ammonia aqueous solution by centrifugation, and then a solvent is added to the wet silica gel so that the wet silica gel is turned into a silica sol again. A hydrophobizing agent is added to hydrophobize the surfaces of the silica particles.

Next, the solvent is removed from the silica sol subjected to the hydrophobizing treatment to thereby obtain target silica particles. In addition, the silica particles obtained described above may be treated with a hydrophobizing agent again.

Examples of the hydrophobizing agent which may be used for the above-described hydrophobizing treatment of the surfaces of the specific silica particles include common organosilicon compounds.

Specific examples of the hydrophobizing agent include known organosilicon compounds having an alkyl group (for example, a methyl group, an ethyl group, a propyl group, or a butyl group). Specific examples thereof include silane compounds (such as methyltrimethoxysilane, dimethyldimethoxysilane, trimethylcholorosilane, and trimethylmethoxysilane), and silazane compounds (such as hexamethyldisilazane, and tetramethyldisilazane).

Among these hydrophobizing agents, hexamethyldisilazane is suitable from the viewpoint of excellent reactivity with the hydroxyl groups on the surface of the silica particle.

The hydrophobizing agents may be used alone or in combination of two or more kinds thereof.

For the hydrophobizing treatment of the surfaces of the silica particles, a dry method such as a spray dry method in which a hydrophobizing agent or a solution including a hydrophobizing agent is sprayed to silica particles floating in a gas phase, a wet method in which silica particles are dipped in a solution including a hydrophobizing agent and dried, and a mixing method in which a hydrophobizing agent and silica particles are mixed using a mixer, and the like may be adopted.

In addition, after the surfaces of the silica particles are treated with a hydrophobizing agent, a step of washing the silica particles with a solvent and removing the remaining hydrophobizing agent and a low boiling point residual fraction, or the like may be added.

When the surfaces of the silica particles are treated with a hydrophobizing agent, hydroxyl groups present on the surfaces of the silica particles are reduced as much as possible to form an almost uniform surface-treated layer. Thus, the aggregation of silica particles by a hydroxyl bond between the hydroxyl groups is prevented and monodispersion silica particles are easily obtained. From this viewpoint, it is preferable to improve the reactivity between the surfaces of the silica particles and the hydrophobizing agent.

In order to improve the reactivity between the surfaces of the silica particles and the hydrophobizing agent, for example, (1) a method of enhancing the reactivity of hydroxyl groups by adjusting the pH of the hydroxyl groups on the surfaces of the silica particles may be used. When the pH is adjusted by this method, contaminants (foreign substances and impurities) on the surfaces of the silica particles may also be removed, and thus the reaction between the hydroxyl groups and the hydrophobizing agent is further improved.

In addition, when the surfaces of the silica particles are treated with a hydrophobizing agent, (2) a reduction in the reactivity of the hydrophobizing agent by lowering the temperature at the time of the hydrophobizing treatment, decreasing the concentration of the hydrophobizing agent, adding a low boiling point alcohol solvent, and decreasing the stirring velocity, is effective to enhance reaction uniformity between the surfaces of the silica particles and the hydrophobizing agent and to obtain an almost uniform surface-treated layer.

As described above, according to the hydrophobizing treatment in which the hydroxyl groups on the surfaces of the silica particles reacts with the hydrophobizing agent, the aggregation of the specific silica particles themselves caused by the hydroxyl groups is prevented and flaking of the hydrophobizing-treated layer when a physical load is applied from the outside is prevented (that is, the hydrophobizing-treated layer is a layer that is excellent in scraping stress resistance). As a result, even when a physical load is applied from the outside, the function of the hydrophobizing-treated layer is maintained and the monodispersion state is maintained. Thus, the above-described effects are sufficiently exhibited by using the specific silica as an external additive.

Other External Additives

The electrostatic charge image developing toner of the exemplary embodiment preferably contains external additives other than the above specific silica particles.

Examples of the external additive include inorganic particles. Examples thereof include TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surfaces of the inorganic particles as an external additive are preferably treated with a hydrophobizing agent. The hydrophobizing treatment is performed by, for example, dipping the inorganic particles in a hydrophobizing agent. The hydrophobizing agent is not particularly limited and examples thereof include a silane coupling agent, a silicone oil, a titanate coupling agent, and an aluminum coupling agent. These agents may be used singly or in combination of two or more kinds thereof.

Typically, the amount of the hydrophobizing agent is, for example, from 1 part by weight to 10 parts by weight with respect to 100 parts by weight of the inorganic particles.

Examples of the external additive also include resin particles (resin particles such as polystyrene, PMMA, and melamine resin particles) and a cleaning aid (for example, metal salt of higher fatty acid represented by zinc stearate, and fluorine polymer particles).

It is preferable that the electrostatic charge image developing toner of the exemplary embodiment contains TiO₂ particles and/or SiO₂ particles and more preferably TiO₂ particles and SiO₂ particles among these external additives. The SiO₂ particles do not include particles included in the above-described specific silica particles.

An electrostatic charge image developing toner having excellent brilliance in an image to be formed may be obtained by using the TiO₂ particles in combination together with SiO₂ particles as an external additive.

When the TiO₂ particles are used in combination together with SiO₂ particles in the exemplary embodiment, the content ratio (weight ratio) between the TiO₂ particles and the SiO₂ particles is preferably TiO₂ particles:SiO₂ particles=1:2 to 1:11 and more preferably 1:5 to 1:9. The content of the SiO₂ particles in the calculation of the content ratio is the total amount of the SiO₂ particles other than the specific silica particles and specific silica particles.

The content ratio may be measured by measuring the intensity ratio between characteristic X-rays derived from the respective elements of Ti and Si using a X-ray fluorescence method.

X-ray fluorescence ZSX Primus 2 manufactured by Rigaku Corporation is used and measurement is made under the measurement conditions of Si: a tube voltage of 30 V, a tube current of 100 mA, a primary X-ray filter of Be, a dispersive crystal of RX4, and a slit of S4, and Ti: a tube voltage of 60 V, a tube current of 50 mA, a primary X-ray filter of Al, and a dispersive crystal of LiF1 for a measurement time of 40 deg/min. A sample obtained by independently adding the TiO₂ particles or SiO₂ particles to the toner particles and mixing the particles using a Henschel mixer at a peripheral velocity of 22 m/s for 3 minutes is measured by the above-described measurement method and first the calibration curve is created.

Using the calibration curve, the content ratio (weight ratio) between the TiO₂ particles and the SiO₂ particles is calculated. In the evaluation, in the case of using a toner in a cartridge or a toner in a developer, a carrier component is removed with a magnet and then evaluation is performed.

The content of the TiO₂ particles is preferably from 0.1 part by weight to 5 parts by weight, more preferably from 0.2 parts by weight to 3 parts by weight, and still more preferably from 0.4 parts by weight to 1.5 parts by weight with respect to 100 parts by weight of the toner particles.

The volume average particle diameter of the TiO₂ particles is preferably from 0.01 μm to 1 μm and more preferably from 0.02 μm to 0.5 μm.

The content of the SiO₂ particles is preferably from 0.1 part by weight to 10 parts by weight and more preferably from 0.2 parts by weight to 5 parts by weight with respect to 100 parts by weight of the toner particles.

The volume average particle diameter of the SiO₂ particles is preferably from 0.01 μm to 0.5 μm, more preferably from 0.02 μm to 0.4 μm, and still more preferably from 0.1 μm to 0.3 μm.

In the method of removing a carrier component with a magnet, 1 g of a developer is added to a 200 ml beaker charged with 100 ml of a 5% aqueous sodium dodecylbenzenesulfonate solution, and the components are mixed with an ultrasonic cleaner (USK-1) at a liquid temperature of 20° C. for 1 minute. Then, in a state in which a magnet (ANFK026) is placed on the beaker at the lower part, the magnet adsorbs the carrier at the lower part. In a state in which the magnet is placed on the beaker at the lower part not to allow the carrier to flow out, the beaker is inclined and the supernatant liquid is removed until the supernatant liquid is thoroughly poured out.

The supernatant liquid collected by repeating the above operation 3 times is repeatedly dried and thus a sufficient amount of the sample required for analysis is collected.

It is presumed that since the TiO₂ particles easily adhere to the toner projection portion and easily come into contact with the specific silica in the external addition step, the dispersion of the specific silica is promoted, and the specific silica is uniformly dispersed on the surface of the toner.

In the case of using the SiO₂ particles in combination together with the TiO₂ particles, it is presumed that since the SiO₂ particles have a negative charge compared to the TiO₂ particles and have a larger specific surface area compared to the specific silica, due to the contact of the SiO₂ particles with the TiO₂ particles, the charging of the TiO₂ particles is increased and the electrostatic adhesive force between the TiO₂ particles and the specific silica is increased.

In the exemplary embodiment, the total amount of all external additives is preferably from 0.1 part by weight to 20 parts by weight, more preferably from 0.2 parts by weight to 15 parts by weight, and still more preferably from 0.5 parts by weight to 10 parts by weight with respect to 100 parts by weight of the toner particles.

Preparing Method of Toner

The preparing method of the toner in the exemplary embodiment is not particularly limited and may be appropriately selected from known methods. The toner may be prepared by adding an external additive to toner particles, prepared by a known method, using a known method.

As the preparing method of the toner particles, for example, any method may be used. Examples thereof include a kneading and pulverizing method of kneading, pulverizing and classifying a binder resin, a metallic pigment, a release agent, a charge-controlling agent, and the like, if necessary, a method of changing the shape of the particles obtained from the kneading and pulverizing method by mechanical impact or thermal energy; an emulsion aggregating method of mixing a dispersion in which a binder resin is emulsified and dispersed, and dispersions of a metallic pigment, a release agent, a charge-controlling agent, and the like, if necessary, and aggregating, heating and coalescing the mixture to obtain toner particles; an emulsion polymerizing aggregating method of emulsifying and polymerizing polymerizable monomers of a binder resin, mixing a dispersion of a metallic pigment, a release agent, a charging control agent, and the like, if necessary, with the prepared dispersion and aggregating, heating and coalescing the mixture to obtain toner particles; a suspension and polymerization method of suspending polymerizable monomers for obtaining a binder resin, a solution of a metallic pigment, a release agent, a charging control agent, and the like, if necessary, in an aqueous solvent; a dissolving and suspension method of suspending a solution of a binder resin, a metallic pigment, a release agent, a charging control agent, and the like, if necessary, in an aqueous solvent and granulating the suspension; an in-liquid drying method of suspending and dispersing an oil component obtained by dissolving and dispersing a binder resin, a brilliant pigment, and other additives in an organic solvent in an aqueous medium, and then removing the solvent; and a method of heating and spheroidizing toner particles obtained by the above methods. The toner is prepared by externally adding an external additive to the toner particles, prepared by these methods, using a known method. Specific examples of the method of heating and spheroidizing include Angmill (manufactured by Hosokawamicron Corporation), Hybridization (manufactured by Nara Machinery Co., Ltd.), Kryptron (manufactured by EARTHTECHNICA Co., Ltd.), and NOBILTA (manufactured by Hosokawamicron Corporation). The shape of the toner may be controlled by controlling the peripheral velocity of a stirring blade, a stirring time, the glass transition temperature of the toner particles and resin particles, and the temperature in the device at the time of stirring. In addition, a method of using the toner particles obtained in the above methods as the cores, further attaching aggregated particles thereto, and thermally coalescing the toner and the particles to give a core-shell structure may be used.

Among these methods, the toner in the exemplary embodiment is preferably a toner including toner particles obtained by the kneading and pulverizing method.

Specific examples of the preparing method of the toner particles by the kneading and pulverizing method include a method of melting and kneading a binder resin, a metallic pigment, a release agent, and the like using a pressure kneader, a roll mill, an extruder and the like, dispersing the mixture, finely pulverizing the mixture using a jet mill and the like after cooling, and classifying particles using a classifier such as a wind classifier to obtain toner particles having a desired particle diameter.

Electrostatic Charge Image Developer

An electrostatic charge image developer according to the exemplary embodiment (hereinafter, also referred to as “developer”) is not particularly limited as long as the developer contains the electrostatic charge image developing toner of the exemplary embodiment, and may be a single component developer including only the toner and may be a two-component developer obtained by mixing the toner and a carrier. In the case of a single component developer, the toner may be a toner including magnetic metal particles or a non-magnetic single component toner not including magnetic metal particles.

The carrier is not particularly limited and a known carrier may be used. Examples of the carrier include resin coated carriers in which the surface of the core formed of magnetic particles is coated with a coating resin, magnetic particle dispersion type carriers in which magnetic particles are dispersed and mixed in a matrix resin, resin impregnation type carriers in which porous magnetic particles are impregnated with resin, and resin dispersion type carrier in which conductive particles are dispersed and mixed in a matrix resin.

The magnetic particle dispersion type carriers, the resin impregnation type carriers and the conductive particle dispersion type carriers may be carriers in which the constituent particles of the carrier are cores and coated with a coating resin.

Examples of the magnetic particles include magnetic metals such as iron, nickel, and cobalt, and magnetic oxides such as iron oxide, ferrite and magnetite.

Specific examples of the carrier include the following resin coated carrier. Examples of nucleus particles of the carrier include a normal iron powder, ferrite, a granulated magnetite, and the like, and the volume average particle diameter thereof is preferably from 20 μm to 200 μm.

Examples of the coating resin of the resin coated carrier include homopolymers or copolymers made of two or more kinds of monomers of styrenes such as styrene, parachlorostyrene and α-methylstyrene; α-methylene fatty acid monocarboxylic acids such as methyl acrylate, ethyl acrylate, n-propyl acrylate, lauryl acrylate, 2-ethylhexyl acrylate, methyl methacrylate, n-propyl methacrylate, lauryl methacrylate and 2-ethylhexyl methacrylate; nitrogen-containing acryls such as dimethylaminoethyl methacrylate; vinyl nitriles such as acrylonitrile and methacrylonitrile; vinyl pyridines such as 2-vinylpyridine and 4-vinylpyridine; vinyl ethers such as vinyl methyl ether and vinyl isobutyl ether; vinyl ketones such as vinyl methyl ketone, vinyl ethyl ketone and vinyl isopropenyl ketone; olefins such as ethylene and propylene; fluorine-containing vinyl monomers such as vinylidene fluoride, tetrafluoroethylene and hexafluoroethylene; acrylic modified silicone resins such as acrylic modified polydimethylsiloxan, as well as silicone resins including methyl silicone and methylphenyl silicone, polyesters including bisphenol and glycol, epoxy resins, polyurethane resins, polyamide resins, cellulose resins, polyether resins, and polycarbonate resins. These resins may be used alone or in combination of two or more kinds thereof. The coating amount of the coating resin is preferably in the range of from about 0.1 part by weight to 10 parts by weight and more preferably in the range of from about 0.5 part by weight to 3.5 parts by weight with respect to 100 parts by weight of the nucleus particles.

The carrier is prepared using, for example, a heating kneader, a heating Henschel mixer, or a UM mixer. Depending on the amount of the coating resin, a heating fluidized bed, a heating kiln or the like is used.

Conductive Material

The coating layer used in the exemplary embodiment preferably includes a conductive material.

Specific examples of the conductive material include metals such as gold, silver, and copper; carbon black; single-component conductive metal oxides such as titanium oxide and zinc oxide; and composite materials obtained by coating the surfaces of fine particles of titanium oxide, zinc oxide, aluminum oxide, aluminum borate, potassium titanate, tin oxide, and indium tin oxide, with a conductive metal oxide.

Among these, aluminum oxide or tin oxide is preferable and aluminum oxide may be used in combination together with tin oxide.

Although the details are not clear, it is considered that in the case of using aluminum oxide in combination together with tin oxide, since the electron orbit structure of these metals is similar to a silanol group and a charge leakage path is easily formed through a hydrophilic group, the effects of the present invention may be easily obtained.

Doped oxide particles may be used. Examples of doped inorganic oxide particles include antimony-doped tin oxide, tin-doped indium oxide, and aluminum-doped zinc oxide. The doped inorganic oxide particles are prepared by applying a known method. For example, a solid phase method such as pulverization, a vapor phase method such as a flame method, a plasma method, a vacuum deposition method and a sputtering method, and a liquid phase method such as a coprecipitation method, a homogeneous precipitation method, a metal alkoxy method and a spray drying method are used. Among these, a dry solid-phase method is preferable for the controllability of a particle size and decreased incorporation of impurities.

The conductive materials used in the exemplary embodiment may be used alone or in combination of two or more kinds thereof.

The content of the inorganic oxide particles in the coating layer is preferably from 0.2% by weight to 10% by weight, and more preferably from 0.4% by weight to 5.0% by weight with respect to the carrier from the viewpoint of maintaining the strength of the coating layer and adjusting the resistance of the carrier.

Other Components

The coating layer in the exemplary embodiment may contain known components used for a coating layer as other components. For example, the coating layer may contain a charge-controlling agent and the like.

The charge-controlling agent is not particularly limited and a known charge-controlling agent used for a carrier may be used. Examples thereof include nigrosine dyes, benzimidazole compounds, quaternary ammonium salt compounds, alkoxylated amines, alkylamides, molybdic acid chelate pigments, triphenylmethane compounds, salicylic acid metal complexes, azo chromium complexes, and copper phthalocyanine and any of these may be used. Among these, quaternary ammonium salt compounds, alkoxylated amines, and alkylamides are preferable.

The amount of the charge-controlling agent added is preferably 0.001 part by weight to 5 parts by weight and more preferably 0.01 part by weight to 0.5 parts by weight when the weight of the core particles is 100 parts by weight.

When the amount is within the above range, the resin coating layer has a sufficient strength, the carrier which is not easily subjected to change in quality stress in use is obtained and the dispersiveness of the conductive material is excellent.

The mixing ratio between the toner and the carrier in the developer is not particularly limited and is appropriately selected in accordance with the purpose.

Image Forming Method

An image forming method using the electrostatic charge image developing toner according to the exemplary embodiment will be described. The electrostatic charge image developing toner of the exemplary embodiment is used in an image forming method by using known electrophotography. Specifically, the toner is used in an image forming method having the following steps.

That is, a preferable image forming method has a latent image forming step of forming an electrostatic latent image on a surface of an image holding member, a developing step of developing the electrostatic latent image formed on the surface of the image holding member with a toner to form a toner image, a transfer step of transferring the toner image to a surface of a transfer medium, and a fixing step of fixing the toner image transferred to the surface of the transfer medium. The electrostatic charge image developing toner of the exemplary embodiment is used as the toner. In addition, when an intermediate transfer member serving as a medium for toner image transfer from the image holding member to the transfer medium is used in the transfer step, the effects of the exemplary embodiment are easily exhibited.

A cleaning step of removing the toner remaining on the surface of the image holding member after transfer may be further provided.

The respective steps are general steps such as those disclosed in JP-A-56-40868 and JP-A-49-91231. The image forming method of the exemplary embodiment may be implemented by using a well-known image forming apparatus such as a copy machine and a facsimile.

The electrostatic latent image forming step is a step of forming an electrostatic latent image on an image holding member (photoreceptor).

The developing step is a step of developing the electrostatic latent image by a developer layer on the developer holding member to form a toner image. The developer layer is not particularly limited as long as the developer layer includes the electrostatic charge image developing toner of the exemplary embodiment.

The transfer step is a step of transferring the toner image to a transfer medium. In addition, as the transfer medium in the transfer step, an intermediate transfer member or a recording medium such as paper may be exemplified.

In the fixing step, for example, a method of fixing the toner image transferred to transfer paper to form a copied image by a heating roller fixing device for setting the temperature of the heating roller to a predetermined temperature may be exemplified.

The cleaning step is a step of removing the electrostatic charge image developer remaining on the image holding member.

As the transfer medium, an intermediate transfer member or a recording medium such as paper may be used.

Examples of the recording medium include paper and an OHP sheet, which are used in a copying machine, a printer or the like of an electrophotographic system, and coated paper obtained by coating the surface of plain paper with a resin or the like, art paper for printing, and the like may be suitably used.

The image forming method of the exemplary embodiment may further contain a recycling step. The recycling step is a process step of moving electrostatic charge image developing toner collected in the cleaning step, to the developer layer. The image forming method of the exemplary embodiment including the recycling step may be implemented with an image forming apparatus, such as a copying machine and a facsimile machine, with a toner recycling system. The image forming method may also be applied to a recycling system, in which the toner is collected simultaneously with the development without the cleaning step.

Image Forming Apparatus

An image forming apparatus according to the exemplary embodiment is an image forming apparatus using the electrostatic charge image developing toner of the exemplary embodiment. The image forming apparatus according to the exemplary embodiment will be described.

The image forming apparatus of the exemplary embodiment preferably includes an image holding member, a charging unit that charges the image holding member, an exposing unit that exposes the charged image holding member, to form an electrostatic latent image on the surface of the image holding member, a developing unit that develops the electrostatic latent image with a toner, to form a toner image, a transferring unit that transfers the toner image from the image holding member to a surface of a transfer medium, and a fixing unit that fixes the toner image transferred to the surface of the transfer medium, and the toner is preferably the electrostatic charge image developing toner of the exemplary embodiment.

The image forming apparatus of the exemplary embodiment is not particularly limited as long as the image forming apparatus includes at least the image holding member, the charging unit, the exposing unit, the developing unit, the transferring unit and the fixing unit, and may further contain a cleaning unit, an erasing unit and the like, if necessary.

In the case of an intermediate transfer type apparatus, a transfer unit is configured to have, for example, an intermediate transfer member having a surface to which a toner image is to be transferred, a primary transfer unit that primarily transfers a toner image formed on a surface of an image holding member to the surface of the intermediate transfer member, and a secondary transfer unit that secondarily transfers the toner image transferred to the surface of the intermediate transfer member to a surface of a recording medium.

As the image holding member and the respective units, the structure described in each step of the image forming method is preferably used. As the above each unit, known units in image forming apparatus may be used. The image forming apparatus of the exemplary embodiment may include units and apparatus other than the configuration described above. Further, plural units among the units described above at the same time in the image forming apparatus of the exemplary embodiment may be operated.

Examples of a cleaning unit include a cleaning blade and a cleaning brush.

In the image forming apparatus, for example, a portion including the developing unit may have a cartridge structure (process cartridge) which is detachable from the main body of the image forming apparatus. As the process cartridge, a process cartridge according to the exemplary embodiment that includes at least a developer holding member and accommodates the electrostatic charge image developer according to the exemplary embodiment is suitably used.

Hereinafter, an example of the image forming apparatus according to the exemplary embodiment will be shown but there is no limitation thereto. In addition, main parts shown in the drawing will be described, and the descriptions of the other parts will be omitted.

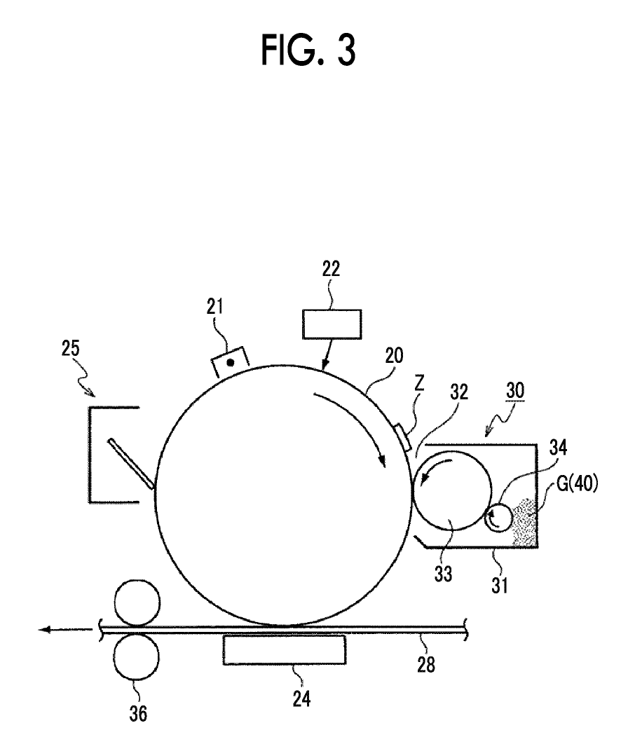

FIG. 3 is a schematic configuration diagram showing an example of the image forming apparatus according to the exemplary embodiment including a developing device to which the electrostatic charge image developer according to the exemplary embodiment is applied.

In the drawing, image forming apparatus according to the exemplary embodiment includes a photoreceptor 20 as an image holding member which rotates in a predetermined direction (an example of the image holding member), and around this photoreceptor 20, a charging device 21 (an example of the charging unit) which charges the photoreceptor 20, an exposure device 22 (an example of the exposure unit), for example, as an electrostatic charge image forming device which forms an electrostatic charge image Z on the photoreceptor 20, a developing device 30 (an example of the developing unit) which visualizes the electrostatic charge image Z formed on the photoreceptor 20, a transfer device 24 (an example of the transfer unit) which transfers a toner image which is visualized on the photoreceptor 20 to a recording sheet 28 which is a recording medium, and a cleaning device 25 (an example of the cleaning unit) which cleans toner remaining on the photoreceptor 20 are disposed in order.

In the exemplary embodiment, as shown in FIG. 3, the developing device 30 has a developing container 31 that accommodates a developer G including a toner 40. The developing container 31 has a developing opening 32 formed to be opposed to the photoreceptor 20, and a developing roll (developing electrode) 33 as a toner holding member arranged to face the developing opening 32. When a predetermined developing bias is applied to the developing roll 33, a developing electric field is formed in a region (developing region) sandwiched between the photoreceptor 20 and the developing roll 33. In the developing container 31, a charge injection roll (injection electrode) 34 as a charge injection member is provided to be opposed to the developing roll 33. Particularly, in the exemplary embodiment, the charge injection roll 34 also acts as a toner supply roll for supplying the toner 40 to the developing roll 33.

Herein, the charge injection roll 34 may be rotated in an arbitrarily selected direction, but in consideration of supply properties of the toner and charge injection properties, it is preferable that the charge injection roll 34 is rotated in the same direction as that of the developing roll 33 at a part opposed to the developing roll 33 with a difference in the peripheral velocity (for example, 1.5 times or greater), and the toner 40 is interposed in a region sandwiched between the charge injection roll 34 and the developing roll 33 and scraped to inject charges.

Next, an operation of the image forming apparatus according to the exemplary embodiment will be described.

When an image forming process is started, first, the surface of the photoreceptor 20 is charged by the charging device 21, the exposure device 22 forms an electrostatic charge image Z on the charged photoreceptor 20, and the developing device 30 visualizes the electrostatic charge image Z as a toner image. Then, the toner image on the photoreceptor 20 is transported to a transfer portion, and the transfer device 24 electrostatically transfers the toner image on the photoreceptor 20 to a recording sheet 28 which is a recording medium. The toner remaining on the photoreceptor 20 is cleaned by the cleaning device 25. Thereafter, the toner image on the recording sheet 28 is fixed by a fixing device 36 (an example of the fixing unit) to obtain an image.

Process Cartridge and Toner Cartridge

A process cartridge according to the exemplary embodiment will be described.

The process cartridge according to the exemplary embodiment is a process cartridge including a developing unit which accommodates the electrostatic charge image developer according to the exemplary embodiment and develops an electrostatic charge image formed on a surface of an image holding member as a toner image with an electrostatic charge image developer, and is detachable from the image forming apparatus.

Without being limited to the configuration described above, the process cartridge according to the exemplary embodiment may have a configuration including a developing device, and, if necessary, at least one selected from other units such as the image holding member, the charging unit, an electrostatic charge image forming unit, and a transfer unit.

Hereinafter, an example of the process cartridge according to the exemplary embodiment will be shown. However, there is no limitation thereto. Main parts shown in the drawing will be described, but descriptions of other parts will be omitted.

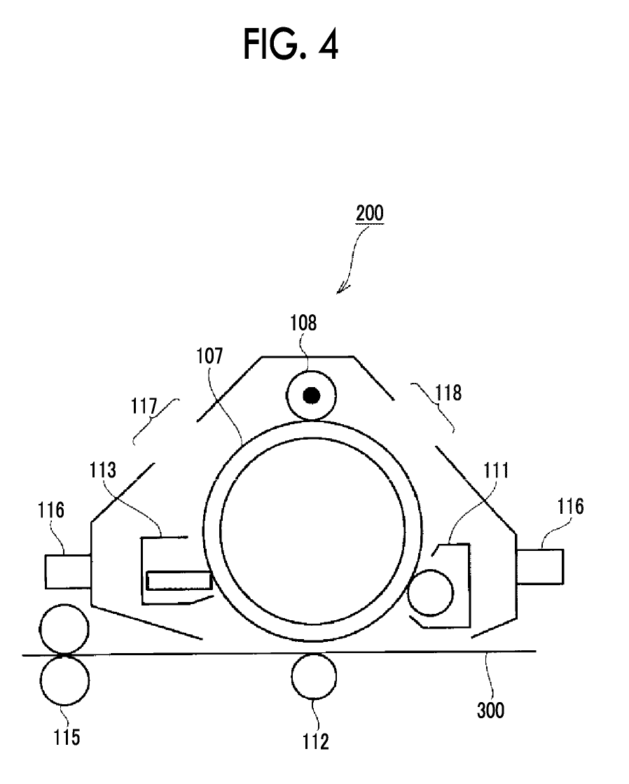

FIG. 4 is a schematic configuration diagram showing the process cartridge according to the exemplary embodiment.

A process cartridge 200 shown in FIG. 4 is formed as a cartridge having a configuration in which a photoreceptor 107 (an example of the image holding member), a charging roll 108 (an example of the charging unit) provided around the photoreceptor 107, a developing device 111 (an example of the developing unit), and a photoreceptor cleaning device 113 (an example of the cleaning unit) are integrally combined and held by, for example, a housing 117 provided with a mounting rail 116 and an opening 118 for exposure.

In FIG. 4, the reference numeral 112 represents a transfer device (an example of the transfer unit), the reference numeral 115 represents a fixing device (an example of the fixing unit), and the reference numeral 300 represents a recording sheet (an example of the recording medium).

The image forming apparatus shown in FIG. 3 is an image forming apparatus having a configuration in which a toner cartridge (not shown) is freely detachable, and the developing device 30 is connected to the toner cartridge via a toner supply tube (not shown). In addition, when the toner contained in the toner cartridge runs low, the toner cartridge may be replaced.

### EXAMPLES

Hereinafter, the exemplary embodiment will be described in detail with reference to Examples and Comparative Examples, but the exemplary embodiment is not limited to these examples.

In the following examples, unless specified otherwise, “part” represents “part by weight” and “%” represents “% by weight”.

Preparation of Toner Particles

Preparation of Toner Particles 1

A mixture of 100 parts by weight of a linear polyester resin (linear polyester obtained from terephthalic acid/bisphenol A ethylene oxide abduct/cyclohexane dimethanol, glass transition temperature (Tg): 62° C., number-average molecular weight (Mn): 4,000, weight-average molecular weight (Mw): 35,000, acid value: 12, hydroxyl value: 25), and 15 parts by weight of a brilliant pigment (2173EA, manufactured by Showa Aluminum Powder K.K) is kneaded with an extruder and pulverized with a pulverizer of surface pulverizing system. Then, the particles are classified into fine particles and coarse particles by a wind classifier. Thus, toner particles having a volume average particle diameter D50 of 9.0 μm and a C/D of 0.780 are obtained.

Preparation of Toner Particles 2

Toner particles having a volume average particle diameter D50 of 15 μm and a C/D of 0.800 are obtained in the same manner as in the preparation of Toner 1 except that the pulverizing strength of the pulverizer of surface pulverizing system is adjusted.

Preparation of Toner Particles 3

Toner particles having a volume average particle diameter D50 of 20 μm and a C/D of 0.820 are obtained in the same manner as in the preparation of Toner 1 except that the pulverizing strength of the pulverizer of surface pulverizing system is adjusted.

Preparation of Toner Particles 4

Toner particles having a volume average particle diameter D50 of 15 μm and a C/D of 0.710 are obtained in the same manner as in the preparation of Toner 1 except that the pulverizing strength of the pulverizer of surface pulverizing system is adjusted.

Preparation of Toner Particles 5

15 parts by weight of a brilliant pigment (2173EA, manufactured by Showa Aluminum Powder K.K), 412.4 parts by weight of ethyl acetate, and 12.6 parts by weight of Disparlon DA-703-50 (polyester acid amide amine salt, manufactured by Kusumoto Chemicals, Ltd.), from which a solvent has been removed, are dissolved and dispersed using a DCP mill to prepare a pigment dispersion. 30 parts by weight of paraffin wax (melting point: 75° C.) and 270 parts by weight of ethyl acetate are pulverized by a wet process under the condition cooled to 5° C. using a DCP mill to prepare a wax (release agent) dispersion. 300 parts by weight of a polyester resin formed from a propylene oxide adduct of bisphenol A, an ethylene oxide adduct of bisphenol A, and a terephthalic acid derivative (Mw: 50,000, Mn: 3,000, acid value: 15 mgKOH/g, hydroxyl value: 27 mgKOH/g, Tg: 65° C.), 267 parts by weight of the pigment dispersion, 400 parts by weight of the wax dispersion, and 20 parts by weight of hydrophobic silicon oxide fine particles (R972 manufactured by Nippon Aerosil Co. , Ltd., average particle diameter: 16 nm) are mixed and well stirred to become uniform (the liquid obtained is designated as a liquid A). On the other hand, 124 parts by weight of calcium carbonate dispersion obtained by dispersing 40 parts by weight of calcium carbonate in 60 parts by weight of water, 99 parts by weight of a 2% aqueous solution of Celogen BS-H (manufactured by Dai-ichi Kogyo Seiyaku Co., Ltd.), and 157 parts by weight of water are stirred for 3 minutes by using a homogenizer (Ultra-Turrax, manufactured by IKA Works, Inc.) (the liquid obtained is designated as a liquid B). Further, 345 parts by weight of the liquid B and 250 parts by weight of the liquid A are stirred at 10,000 rpm for 1 minute by using a homogenizer (Ultra-Turrax, manufactured by IKA Works, Inc.) to suspend the mixed solution, and then after adding 110 parts by weight of a 0.3% ammonia aqueous solution to the mixed solution, the solvent is removed by stirring with a propeller type stirrer for 48 hours at room temperature and normal pressure. Hydrochloric acid is added to remove calcium carbonate, and then washing with water, drying and classification are conducted to obtain a toner. Then, while maintaining the temperature in the device at 65° C., stirring is conducted at 2,000 rpm for 10 minutes using NOBILTA NOB-300 (manufactured by Hosokawamicron Corporation). Thus, toner particles having a volume-average particle diameter of 15 μm and a C/D of 0.820 are obtained.

Preparation of Toner Particles 6

Toner particles having a volume average particle diameter of 15 μm and a C/D of 0.900 are obtained by maintaining the temperature in the device at 63° C., stirring Toner Particles at 3,000 rpm for 10 minutes using NOBILTA NOB-300 (manufactured by Hosokawamicron Corporation).

Preparation of Specific Silica Particles

Preparation of Specific Silica Particles 1

251 parts by weight of methanol and 42.5 parts by weight of a 10% ammonia aqueous solution are put to a 3L-glass reaction vessel equipped with a metal stirring rod, a dropping nozzle (micro-tube pump made of Teflon (registered trademark)) and a thermometer, and are stirred and mixed. Thus, an alkaline catalyst solution is obtained.

Next, the temperature of the alkaline catalyst solution is adjusted to 25° C., and the alkaline catalyst solution is substituted with nitrogen. Then, while stirring the alkaline catalyst solution, 450 parts by weight of tetramethoxysilane (TMOS), 10 parts by weight of tetraethoxysilane, and 270 parts by weight of an ammonia aqueous solution having a catalyst (NH₃) concentration of 4.44% are simultaneously added dropwise by the following amounts supplied. Thus, a suspension of silica particles (silica particle suspension) is obtained.

Here, the amount of silanes supplied while stirring at 30 rpm is set to 2.57 parts by weight/min and the amount of 4.44% ammonia aqueous solution supplied is set to 1.54 parts by weight/min. At this time, the temperature is controlled to 27° C. to 30° C.

Next, the obtained suspension of hydrophilic silica particles (hydrophilic silica particle dispersion) is dried by spray drying while the solvent is removed therefrom to thereby obtain a hydrophilic silica particle powder.

Subsequently, 100 parts of the powder are put into a glass reaction vessel, 200 parts of distilled water are added thereto, and the pH of the resultant solution is adjusted to 3.5 using sodium hydroxide and acetic acid. Then, vacuum distillation is performed using an evaporator. 200 parts of toluene are added and stirred at 50 rpm, 30 parts by weight of hexamethyldisilazane (HMDS) are added dropwise with respect to the hydrophilic silica particle powder over 2 hours, and 50 parts of ethanol are added dropwise thereto over 1 hour. The mixture is further stirred for 2 hours to effect the reaction. At this time, the temperature reaches 21° C. to 25° C. Thereafter, the mixture is frozen and dried using a centrifugal settler for about 60 hours to obtain a hydrophobic silica particle powder whose surface is treated with a hydrophobizing agent.

Thus, Specific silica particles 1 are obtained.

Preparation of Specific Silica Particles 2

Specific silica particles 2 are obtained in the same manner as in the preparation of Specific silica particles 1 except that the amount of 10% ammonia aqueous solution is changed from 42.5 parts by weight to 41.5 parts by weight.

Preparation of Specific Silica Particles 3

Specific silica particles 3 are obtained in the same manner as in the preparation of Specific silica particles 1 except that the amount of 10% ammonia aqueous solution is changed from 42.5 parts by weight to 45.4 parts by weight.

Preparation of Specific Silica Particles 4

Specific silica particles 4 are obtained in the same manner as in the preparation of Specific silica particles 1 except that the amount of silanes supplied is changed from 2.57 parts by weight/min to 0.99 parts by weight/min, and the amount of 4.44% ammonia aqueous solution supplied is changed from 1.54 parts by weight/min to 0.59 parts by weight/min.

Preparation of Specific Silica Particles 5

Silica particles 5 are obtained by using a silica having a number-average particle diameter of 150 nm produced by a gas phase method and performing a hydrophobizing treatment with HMDS in the same manner as in the preparation of Silica particles 1.

Preparation of Specific Silica Particles 6

Specific silica particles 6 are obtained in the same manner as in the preparation of Specific silica particles 1 except that the amount of 10% ammonia aqueous solution is changed from 42.5 parts by weight to 40.5 parts by weight.

Preparation of Toner

Specific silica particles, TiO₂ particles (T805 manufactured by Nippon Aerosil Co., Ltd.) and SiO₂ particles (R972 manufactured by Nippon Aerosil Co., Ltd.) are added to 100 parts by weight of toner particles shown in Table 1 respectively in the amounts shown in Table 1, and are mixed using a Henschel mixer at a peripheral velocity of 22 m/s for 3 minutes. Then, the mixture is sieved through a vibration sieve having an opening of 45 μm to prepare toners to be used for Examples and Comparative Examples. In Table 1, an example with “-” in the column of TiO₂ or SiO₂ does not contain the corresponding compound. In addition, in Table 1, for example, 1 in the column of “No.” of the toner particles indicates that Toner particles 1 are used and for example, 3 in the column “No.” of Specific silica particles indicates that Specific silica particles 3 are used, respectively.

Preparation of Carrier

Preparation of Carrier 1

12 parts of 3-methacryloxypropyl methyldimethoxysilane (trade mane: KBM-502, manufactured by Shin-Etsu Chemical Co., Ltd.), and 3 parts of tetraethoxysilane (KBE04 manufactured by Shin-Etsu Chemical Co., Ltd.) are mixed and cooled at 20° C. Next, 2 parts of 0.25 N acetic acid are added thereto and then the mixture is allowed to stand overnight at a temperature from 20° C. to 30° C. to perform hydrolyzation. 35 parts of isopropyl alcohol and 300 parts of toluene are added to the resultant solution to thereby obtain a silicone resin solution.

Further, 200 parts of the silicone resin in terms of solid content, 100 parts of Hitaloid 6500 (manufactured by Hitachi Chemical Co., Ltd., hydroxyl value: 30) in terms of solid content, 10 parts of 3-aminopropyl trimethoxysilane (trade name: KBM-903, manufactured by Shin-Etsu Chemical Co., Ltd.), 250 parts of tin oxide particles (trade name: Pastoran 4300, manufactured by Mitsui Mining & Smelting Co., Ltd.), and 50 parts of alumina particles (AluC 805 manufactured by Nippon Aerosil Co., Ltd.) are mixed to obtain a solution for forming a coating layer.

231 parts of the solution for forming a coating layer in terms of solid content are put into a fluidized bed coating apparatus (SPIR-A-FLOW, manufactured by freund corp) with respect to 10,000 parts of ferrite particles obtained above and coating is performed for 30 minutes. Then, drying is performed at 150° C. to obtain coated Carrier 1.

Preparation of Carrier 2

Coated carrier 2 is obtained in the same manner as in the preparation of Carrier 1 except that tin oxide particles are not used and 300 parts by weight of alumina particles are used.

Preparation of Carrier 3

Coated carrier 3 is obtained in the same manner as in the preparation of Carrier 1 except that carbon black (trade mane: Ketjen black EC600JD, manufactured by Lion Corporation) is used instead of using tin oxide particles and alumina particles.

Preparation of Developer

32 parts of the toner prepared in each of Examples and Comparative Examples, and 418 parts of Carrier 1 are put into a V blender, and stirred for 20 minute. Then, the mixture is sieved though a sieve having an opening of 212 μm to prepare developers.

Evaluation Test

Measurement of Parameter

Regarding the developer prepared in each of Examples and Comparative Examples, the volume-average particle diameter of the toner particles is measured by the above-described manner. The measurement results are shown in the column of “Volume-average particle diameter (μm)” of Table 1.

In addition, regarding the developer prepared in each of Examples and Comparative Examples, the content of silica particles, having a ratio F/G of the circumferential length F to the circumference G calculated from the equivalent circle diameter E of 1.10 to 3.00, with respect to the total number of the specific silica particles, and the number-average equivalent circle diameter (particle diameter) are measured by the above-described manner. The measurement results are respectively shown in the columns of “Content of Specific surface uneven particles (% by number)” and “Particle diameter d (μm)” of Table 1.

Further, regarding the developer prepared in each of Examples and Comparative Examples, the content ratio (weight ratio) between the TiO₂ particles and the SiO₂ particles is measured by the above-described manner. The measurement results are shown in the column of Ti:Si of Table 1. For example, the result of Examples 1 “1:8” means the content of TiO₂ particles (parts by weight):the content of SiO₂ particles (parts by weight)=1:8.

Evaluation of Brilliance

A solid image is formed in the following manner.

A developer unit of DocuCentre-III C7600 manufactured by Fuji Xerox Co., Ltd. is filled with the developer prepared in each of Examples and Comparative Examples, seasoning is performed thereon overnight in a low temperature and low humidity (10° C., 10 RH %) environment, and then seasoning is performed without any change for 12 hours in a low temperature and low humidity (5° C., 10 RH %) environment. A 3 cm×4 cm solid image in which an amount of toner applied is 3.8 g/m² is continuously formed on 300 sheets of recording paper (OK Topcoat+Paper manufactured by Oji Paper Co., Ltd.) at a fixing temperature of 180° C. and a fixing pressure of 4.3 kg/cm².

Regarding the solid images obtained at the first printing and at the 300th printing, the value of brilliance (A/B) is measured by the aforementioned method. In the evaluation of brilliance, the brilliance is measured at 3 points of each solid image and the average value is shown as an A/B value in the table.

The A/B value is preferably from 2 to 100 and more preferably from 4 to 100.

The allowable evaluation value is 2 or greater. The evaluation results are shown in Table 1.

TABLE 1

| | | | | External additive | | | | | | | | | |
|---|---|---|---|---|---|---|---|---|---|---|---|---|---|
| | | | | Specific silica | | | | TiO₂ particles | SiO₂ particles | Ratio | | | |
| | | | | | Content of | | Amount of | Amount of | Amount of | between | | | |
| | | | | | Specific | | External | External | External | TiO₂ | | Brilliance | |
| | | | | | surface uneven | Particle | addition | addition | addition | and | | A/B | |
| | | Toner particle | | | particles (% | diameter | (parts by | (parts | (parts | SiO₂ | Carrier | First | 300th |
| | | No. | C/D | No. | by number) | (μm) | weight) | by weight) | by weight) | Ti:Si | No. | printing | printing |
| Example | 1 | 1 | 0.780 | 1 | 73 | 0.16 | 1.0 | 0.5 | 3.0 | 1:8 | 1 | 6 | 6 |
| | 2 | 2 | 0.800 | 1 | 73 | 0.16 | 1.0 | 0.5 | 3.0 | 1:8 | 1 | 6 | 6 |
| | 3 | 3 | 0.820 | 1 | 73 | 0.16 | 1.0 | 0.5 | 3.0 | 1:8 | 1 | 6 | 6 |
| | 4 | 4 | 0.710 | 1 | 73 | 0.16 | 1.0 | 0.5 | 3.0 | 1:8 | 1 | 5 | 4 |
| | 5 | 5 | 0.820 | 1 | 73 | 0.16 | 1.0 | 0.5 | 3.0 | 1:8 | 1 | 6 | 3 |
| | 6 | 6 | 0.900 | 1 | 73 | 0.16 | 1.0 | 0.5 | 3.0 | 1:8 | 1 | 6 | 3 |
| | 7 | 2 | 0.800 | 2 | 64 | 0.11 | 1.0 | 0.5 | 3.0 | 1:8 | 1 | 5 | 4 |
| | 8 | 2 | 0.800 | 3 | 76 | 0.29 | 1.0 | 0.5 | 3.0 | 1:8 | 1 | 5 | 3 |
| | 9 | 2 | 0.800 | 4 | 30 | 0.14 | 1.0 | 0.5 | 3.0 | 1:8 | 1 | 6 | 2 |
| | 10 | 2 | 0.800 | 5 | 74 | 0.16 | 1.0 | 0.5 | 3.0 | 1:8 | 1 | 5 | 4 |
| | 11 | 2 | 0.800 | 1 | 73 | 0.16 | 1.0 | 0.5 | — | 1:2 | 1 | 6 | 4 |
| | 12 | 2 | 0.800 | 1 | 73 | 0.16 | 1.0 | 1.0 | 4.5 | 1:11 | 1 | 6 | 3 |
| | 13 | 2 | 0.800 | 1 | 73 | 0.16 | 1.0 | — | — | — | 1 | 6 | 2 |
| | 14 | 2 | 0.800 | 1 | 73 | 0.16 | 1.0 | 0.5 | 3.0 | 1:8 | 2 | 6 | 4 |
| | 15 | 2 | 0.800 | 1 | 73 | 0.16 | 1.0 | 0.5 | 3.0 | 1:8 | 3 | 6 | 3 |
| Comparative | 1 | 2 | 0.800 | 6 | 70 | 0.07 | 1.0 | 0.5 | 3.0 | 1:8 | 1 | 6 | 1 |
| Example | 2 | 5 | 0.820 | 6 | 70 | 0.07 | 1.0 | 0.5 | 3.0 | 1:8 | 1 | 5 | 1 |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles including a binder resin and a metallic pigment, and
silica particles having an equivalent circle diameter E of greater than 0.10 μm,
wherein a relationship between a number-average maximum thickness C and a number-average equivalent circle diameter D of the toner particles satisfies 0.700<C/D<1.220,
a number-average equivalent circle diameter d of the silica particles satisfies 0.10 μm<d<0.30 μm, and
the content of silica particles having a ratio F/G of a circumferential length F to a circumference G calculated from the equivalent circle diameter E of 1 . 10 to 3.00 is 30% by number to 100% by number with respect to the total number of silica particles.

2. The electrostatic charge image developing toner according to claim 1,
wherein the toner particles include aluminum as the metallic pigment.

3. The electrostatic charge image developing toner according to claim 1,
wherein the toner particles include polyester as the binder resin.

4. The electrostatic charge image developing toner according to claim 1,
wherein a glass transition temperature of the binder resin is from 50° C. to 80° C.

5. The electrostatic charge image developing toner according to claim 1,
wherein a weight-average molecular weight of the binder resin is from 7,000 to 500,000.

6. The electrostatic charge image developing toner according to claim 1,
wherein the silica particles are prepared by a sol-gel method.

7. An electrostatic charge image developer comprising:
the electrostatic charge image developing toner according to claim 1; and
a carrier.

8. A toner cartridge that is detachable from an image forming apparatus and accommodates the electrostatic charge image developing toner according to claim 1.
